(19) United States
(12) Patent Application Publication
(10) Pub. No.: US 2005/0134165 A1
(43) Pub. Date: Jun. 23, 2005

(54) Color cathode ray tube

(75) Inventor: Jae Seung Baek, Daegukwangyeok-si (KR)

Correspondence Address: BIRCH STEWART KOLASCH & BIRCH, PO BOX 747, FALLS CHURCH, VA, 22040-0747, US

(73) Assignee: LG. Philips Displays Korea CO., LTD., Kyungsangbuk-Do (KR)

(21) Appl. No.: 10/995,421

(22) Filed: Nov. 24, 2004

(30) Foreign Application Priority Data
Nov. 27, 2003 (KR) 2003-84814

(51) Int. Cl. H01J 29/10; H01J 29/92; H01J 29/88

(52) U.S. Cl. 313/477 R; 313/479; 313/461

(57) ABSTRACT

Disclosed herein is a color cathode ray tube which optimizes the structure of a glass panel and funnel to achieve weight reduction thereof. In the color cathode ray tube, a curvature radius of an outer surface of the panel is in a range of 5000 mm to 100000 mm, and the panel is configured to satisfy an expression: 1.0≦(OAH*CFT)/USD≦1.5, where, OAH is a distance from the outer surface of the panel to a sealing surface between the panel and the funnel, USD is a diagonal length of an effective screen of the panel, and CFT is a thickness of a central region of the panel. The cathode ray tube of the present invention has the effects of reducing manufacturing costs through weight reduction thereof, of lowering the degree of breakage during a heat treatment step included in a manufacturing process of the cathode ray tube, resulting in an improved yield, and of effectively intercepting X-rays generated during operation thereof.

### BACKGROUND OF THE INVENTION

1. Field of the Invention

The present invention relates to a color cathode ray tube having the optimized structure of a panel and funnel.

2. Description of the Related Art

FIG. 1 is a schematic side view, partially shown in section, illustrating the structure of a conventional color cathode ray tube. As shown in FIG. 1, the conventional color cathode ray tube is basically configured in such a manner that a cone-shaped glass funnel 2 is fused to a rear end of a glass panel 1. The panel 1 has a fluorescent plane 4, which is formed as Red, Green and Blue fluorescent materials are applied to an inner surface of the panel 1, and explosion-proof means is fixed at a front side of the panel 1. Such a color cathode ray tube comprises electron guns inserted in a neck portion 13 of the funnel 2 and adapted to emit electron beams 6, a deflection yoke 5 adapted to deflect the electron beams 6, and a shadow mask 3 mounted at an inner side of the panel 1 having a predetermined distance therefrom. The shadow mask 3 is formed with a plurality of electron beam passage holes. In order to support the shadow mask 3 to maintain the predetermined distance from the inner surface of the panel 1, a main frame 7 and an auxiliary frame 8 are fixed to the shadow mask 3, and corner springs 9 are used to connect and support the frames and panel relative to each other. The color cathode ray tube further comprises an inner shield 10 mounted therein to prevent the cathode ray tube from severely affecting by an external earth magnetic field during operation, a reinforcing band 12 mounted to a skirt of the panel 1 and adapted to allow the panel 1 to be less affected by an external shock, and a magnet 11 attached to a rear surface of the deflection yoke 5 and adapted to correct a traveling path of the electron beams 6 to enable them to accurately strike a predetermined portion of the fluorescent plane.

The conventional color cathode ray tube, in the form of a glass envelope obtained by combining the glass panel and glass funnel with each other, is manufactured through a series of pre- and post-processes. The pre-process is a process of applying the fluorescent materials to the inner surface of the panel to form the fluorescent plane, and the post-process comprises several steps as follows. In the first step of this post-process, the panel, which has the fluorescent plane and is internally mounted with the shadow mask, is sealed to the funnel by means of a frit applied to a sealing surface between the panel and the funnel under a high-temperature environment. In succession, the electron guns are inserted in the neck portion of the funnel, and then the interior of the glass envelope is vacuumized through a evacuation step. In such a vacuumized state, the sealed panel and funnel are subjected to high tensile and compressive stresses. To prevent this, the reinforcing band is attached to the skirt of the panel to disperse the high stresses being applied to the panel after the evacuation step. In this way, the manufacture of the cathode ray tube in the form of the glass envelope is completed.

FIG. 2 is a diagram schematically illustrating the distribution of the stresses being applied to the sealed glass panel and funnel after the evacuation step. As shown in FIG. 2, when the interior of the glass envelope is vacuumized, the stresses are generated at the entire portion of the glass envelope due to a difference between external and internal pressures of the glass envelope, causing deformation of the glass envelope, namely, cathode ray tube. That is, a predetermined degree of the compressive stress is generated at the front side of the panel and the rear side of the cone-shaped funnel, and consequently the tensile stress is generated at corners of the panel and a sealing portion between the panel and the funnel. In FIG. 2, dash-lined arrows represent the compressive stress, and solid-lined arrows represent the tensile stress.

Meanwhile, the cathode ray tube, subjecting to the stresses as stated above, starts to form cracks around a certain region thereof vulnerable to an external shock. In this case, the tensile stress applied to the surface of the glass envelope accelerates the progress of cracks, causing explosion of the glass envelope if the external shock is excessive. On the contrary, the compressive stress serves to prevent the cracks from being progressed farther. That is, the compressive stress, generated at the center of the front side of the panel after evacuating the cathode ray tube, can reduce the external shock, whereas the tensile stress, generated at the corners of the panel and the sealing portion between the panel and the funnel, causes explosion at that regions even through the external shock is not so high.

In recent years, color cathode ray tubes become larger and flatter, and resultingly a maximum value of the tensile stress is generated when the interior of the cathode ray tube is vacuumized. That is, as the cathode ray tube becomes thin, the volume of the cathode ray tube is reduced, but the interior vacuum degree thereof is not changed, exacerbating the generation of the tensile stress. Furthermore, in the case of the cathode ray tube configured so that a yoke portion of the funnel has a square form in order to allow the deflection yoke to consume only a low amount of electric power, the tensile stress is excessively generated in the glass envelope due to a structural weakness of the funnel, increasing the possibility of breakage in a heat treatment.

In order to solve the above problems, Japanese Patent No. 2904067 discloses a physical reinforcing method of the glass envelope which comprises a heat treatment step for lowering the tensile stress of the glass envelope and funnel to a stable level and increasing shock-resistance throughout the surface of the glass envelope, providing the glass envelope with the compressive stress. Such a physical reinforcing method, however, inevitably generates a high residual tensile stress, in addition to the compressive stress, due to uneven temperature distribution caused during the heat treatment. This restricts the generation of the compressive stress, causing weight reduction of the glass envelope to be difficult.

Moreover, the cathode ray tube generates X-rays when the electron beams, emitted from the electron guns, strike the fluorescent plane formed at the inner surface of the panel to form an optical image. The X-rays pass through the front side of the panel of the cathode ray tube, and are harmful to the human body.

### SUMMARY OF THE INVENTION

Therefore, the present invention has been made in view of the above problems, and it is an object of the present invention to provide a color cathode ray tube which optimizes the structure of a glass panel and funnel to achieve weight reduction thereof, thereby being capable of effectively eliminating a tensile stress caused when the interior of the cathode ray tube is vacuumized, and of improving shock-resistance thereof.

It is another object of the present invention to provide a color cathode ray tube using an improved glass panel, which can prevent X-rays, generated during operation of the cathode ray tube, from passing through the front side of the panel.

In accordance with one aspect of the present invention, the above and other objects can be accomplished by the provision of a color cathode ray tube comprising: a panel having a fluorescent plane formed at an inner surface thereof; a funnel sealed to the panel in a vacuumized state; electron guns mounted in a neck portion of the funnel and adapted to emit electron beams to the fluorescent plane; a deflection yoke mounted in a yoke portion of the funnel and adapted to deflect the electron beams; and a shadow mask spaced apart from the fluorescent plane formed at the inner surface of the panel by a predetermined distance for color selection, wherein: the panel is configured to satisfy an expression: 1.0≦(OAH*CFT)/USD≦1.5, where, OAH is a distance from the outer surface of the panel to a sealing surface between the panel and the funnel, USD is a diagonal length of an effective screen of the panel, and CFT is a thickness of a central region of the panel.

In accordance with another aspect of the present invention, there is provided a color cathode ray tube comprising: a panel having a fluorescent plane formed at an inner surface thereof; a funnel sealed to the panel in a vacuumized state; electron guns mounted in a neck portion of the funnel and adapted to emit electron beams to the fluorescent plane; a deflection yoke mounted in a yoke portion of the funnel and adapted to deflect the electron beams; and a shadow mask spaced apart from the fluorescent plane formed at the inner surface of the panel by a predetermined distance for color selection, wherein the panel is configured so that a curvature radius of an outer surface thereof is in a range of 5000 mm to 100000 mm, a diagonal length of an effective screen thereof is in a range of 450 mm to 500 mm, and it satisfies an expression: 1.0≦(OAH*CFT)/USD≦1.7, where, OAH is a distance from the outer surface of the panel to a sealing surface between the panel and the funnel, CFT is a thickness of a central region of the panel, and USD is the diagonal length of the effective screen of the panel.

In accordance with yet another aspect of the present invention, there is provided a color cathode ray tube comprising: a panel having a fluorescent plane formed at an inner surface thereof; a funnel sealed to the panel in a vacuumized state; electron guns mounted in a neck portion of the funnel and adapted to emit electron beams to the fluorescent plane; a deflection yoke mounted in a yoke portion of the funnel and adapted to deflect the electron beams; and a shadow mask spaced apart from the fluorescent plane formed at the inner surface of the panel by a predetermined distance for color selection, wherein: a thickness of a central region of the panel is less than or equal to 10 mm; a light transmissibility at the central region of the panel is in a range of 45% to 75%; and the panel has a center blend portion and peripheral blend portions formed at ends of outer longer and shorter edge surfaces and of an outer diagonal surface portion converged at a corner of the panel, the center blend portion having a curvature radius of 20 mm or more, the peripheral blend portions having curvature radii of 3 mm or more, respectively.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic side view, partially shown in section, illustrating the structure of a conventional color cathode ray tube;

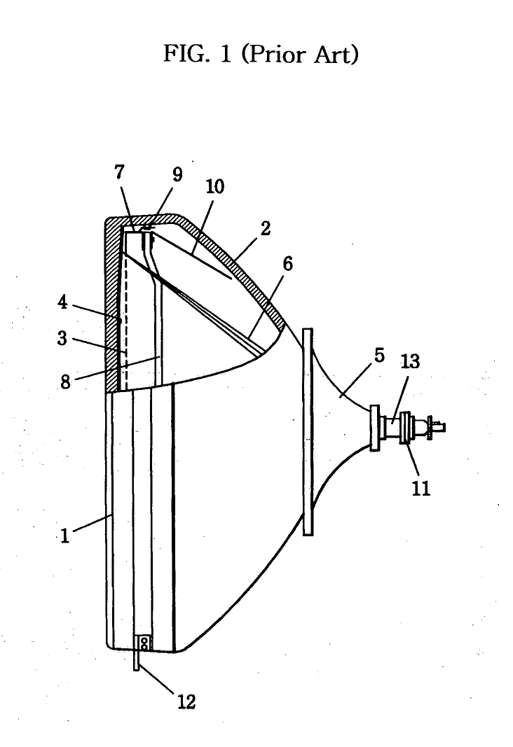

FIG. 2 is a diagram schematically illustrating the distribution of stress being applied to a sealed glass panel and funnel of the conventional color cathode ray tube;

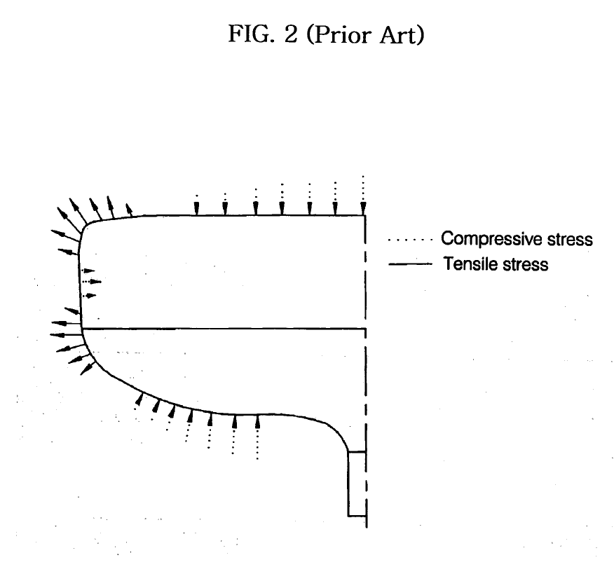

FIGS. 3a and 3b are a front view and a sectional view, respectively, illustrating the configuration of a panel provided in a cathode ray tube in accordance with the present invention;

FIG. 4 is a diagram explaining a name, length and thickness of respective positions of the cathode ray tube formed by sealing a panel and a funnel to each other in accordance with the present invention;

FIG. 5 is a schematic perspective view explaining a wedge ratio of the panel in accordance with the present invention; and

FIG. 6 is a perspective view, partially shown at an enlarged scale, illustrating a corner of the panel having predetermined curvatures at the ends of outer longer and shorter edge surfaces and of an outer diagonal surface portion of the panel.

### DESCRIPTION OF THE PREFERRED EMBODIMENTS

Now, preferred embodiments of the present invention will be explained in detail with reference to the accompanying drawings and tables.

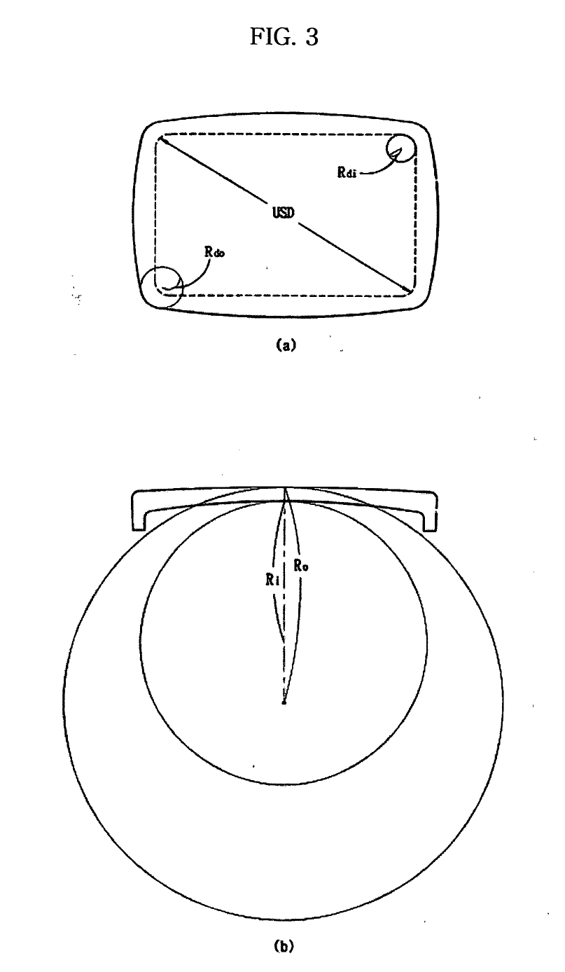

FIGS. 3a and 3b are a front view and a sectional view, respectively, illustrating the configuration of a panel provided in a cathode ray tube in accordance with the present invention. As shown in FIGS. 3a and 3b, the panel of the cathode ray tube according to the present invention is configured to have a rectangular form wherein the length of horizontal sides of the panel is different from that of vertical sides of the panel. The panel is further configured in such a fashion that inner and outer surfaces thereof have predetermined major-axis, minor-axis, and diagonal-axis curvature radii, respectively. In this case, the outer surface of the panel is substantially flat. Such a panel configured as stated above has a fluorescent plane, which is formed as fluorescent materials are applied to an inner surface of the panel, and a bulb-shaped funnel is sealed to a rear side of the panel, completing the cathode ray tube. In FIGS. 3a and 3b, Rₒ designates a curvature radius of the outer surface of the panel, Rᵢ designates a curvature radius of the inner surface of the panel, R_{do} designates a diagonal-axis curvature radius of the outer surface of the panel, and R_{di} designates a diagonal-axis curvature radius of the inner surface of the panel.

In order to assure that the cathode ray tube according to the present invention achieves weight reduction thereof, first, a name, length and thickness of respective regions of the sealed panel and funnel must be defined.

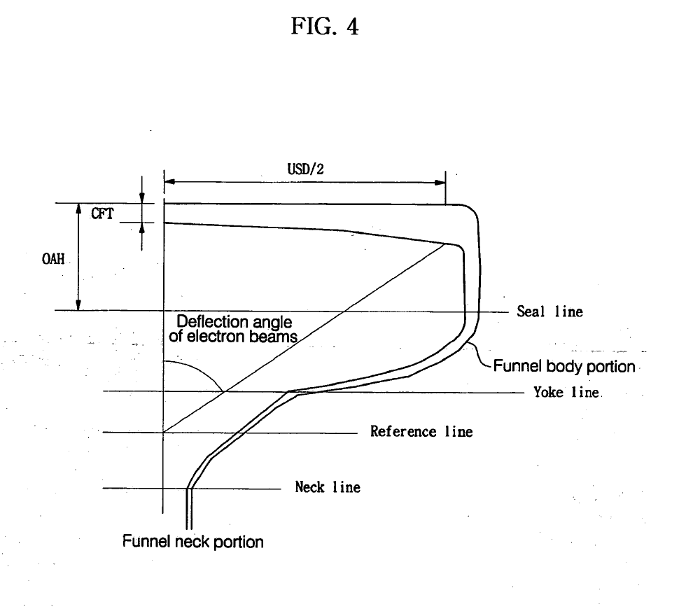

FIG. 4 is a diagram explaining a name, length and thickness of respective regions of the cathode ray tube formed by sealing the panel and the funnel to each other in accordance with the present invention. As shown in FIG. 4, the cathode ray tube, formed by combining the panel and the funnel with each other, has a seal line in the form of a closed curved line along which the panel and the funnel are sealed to each other, a yoke line in the form of a closed curved line serving as a boundary line between a body portion and a yoke portion of the funnel, a neck line in the form of a closed curved line serving as a boundary line along which a neck portion of the funnel is sealed to the yoke portion, and a reference line intermediately located between the yoke line and the neck line and serving as a deflection center of electron beams. Further, in FIG. 4, USD designates a diagonal length of an effective screen of the panel, CFT designates a thickness of a central region of the panel, and OAH designates a distance from the outer surface of the panel to a sealing surface between the panel and the funnel.

The cathode ray tube of the present invention defined as stated above has limit values of the length and thickness of the respective regions thereof as described in the following first and second embodiments.

### First Embodiment

The following Table 1 represents comparative results between a conventional cathode ray tube and the cathode ray tube of the present invention in view of vacuum stress values. In the present embodiment, the curvature radius Rₒ of the outer surface of the panel is in a range of 5000 mm to 100000 mm, and other length and thickness of respective regions of the panel are given as follows.

TABLE 1

| | | | | | | | | | Vacuum | |
|---|---|---|---|---|---|---|---|---|---|---|
| | | | | | | | | | Stress | |
| | Ex. | OAH | CFT | USD | OAH/ | (OAH * CFT)/ | Tm | Tm | (Mpa) | |
| | No. | (mm) | (mm) | (mm) | USD | USD | (%) | (%) | panel | funnel |
| The | 1 | 55.9 | 8.4 | 406.7 | 0.137 | 1.155 | 83.7 | 61.8 | 5.7 | 5.2 |
| present | 2 | 48.9 | 8.4 | 406.7 | 0.120 | 1.010 | 83.7 | 61.8 | 5.2 | 4.8 |
| invention | 3 | 57 | 9.5 | 406.7 | 0.140 | 1.331 | 82.8 | 58.8 | 6.0 | 5.3 |
| | 4 | 50 | 9.5 | 406.7 | 0.123 | 1.168 | 82.8 | 58.8 | 5.8 | 5.1 |
| | 5 | 58 | 10.5 | 406.7 | 0.143 | 1.497 | 81.9 | 56.1 | 5.6 | 5.1 |
| | 6 | 51 | 10.5 | 406.7 | 0.125 | 1.317 | 81.9 | 56.1 | 5.1 | 4.7 |
| The prior | 1 | 63 | 10.5 | 406.7 | 0.155 | 1.627 | 81.5 | 56.1 | 6.5 | 5.8 |
| art | 2 | 63 | 10.5 | 406.7 | 0.155 | 1.627 | 81.5 | 56.1 | 6.6 | 5.7 |

As shown in Table 1, comparing the length and thickness of the respective regions of the panel according to the present invention with those of a conventional panel, it will be appreciated that the thickness CFT of the central region of the panel according to the present invention is smaller than the thickness of 10.5 mm of the prior art, and that the distance OAH from the outer surface of the panel to the sealing surface between the panel and the funnel is smaller than that of the prior art. It will be further appreciated that the ratio of the diagonal length USD of the effective screen of the panel to the distance OAH and the ratio of a value obtained by multiplying the thickness CFT by the distance OAH to the diagonal length USD are smaller than those of the prior art.

That is, in order to prevent the breakage of the cathode ray tube due to an external shock and to achieve weight reduction of the cathode ray tube, the panel of the cathode ray tube according to the present embodiment employs a value of (OAH*CFT)/USD in a range of 1.0 to 1.5. If the value of (OAH*CFT)/USD is less than 1.0, both the distance OAH and the thickness CFT are excessively reduced, deteriorating the structural strength and explosion-proof character of the panel against an external shock. Conversely, if the value of (OAH*CFT)/USD is greater than 1.5, it makes impossible to achieve weight reduction of the cathode ray tube, increasing material costs thereof. This also increases a thickness of a peripheral region of the panel, resulting in a high degree of breakage during the heat treatment of the cathode ray tube, deteriorating a yield thereof. Therefore, it is preferable to limit the value of (OAH*CFT)/USD into the above described range.

As another technical solution for preventing the breakage of the cathode ray tube due to an external shock and achieving weight reduction of the cathode ray tube, the panel of the present embodiment employs the diagonal length USD of the effective screen of the panel of 500 mm and less. Preferably, in consideration of a tolerance error in design of different various cathode ray tubes, the diagonal length USD is in a range of 400 mm to 450 mm.

In this case, the thickness CFT of the panel according to the present invention is less than or equal to 10 mm. Likewise, in consideration of the tolerance error in design of different various cathode ray tubes, and in order to reduce material costs through weight reduction of the panel, the thickness CFT is preferably in a range of 8 mm to 9 mm.

The ratio of the diagonal length USD of the effective screen of the panel to the distance OAH from the outer surface of the panel to the sealing surface between the panel and the funnel, namely, the value of OAH/USD is less than or equal to 0.15.

Meanwhile, a wedge ratio of the panel increases as the thickness CFT of the panel decreases. This results in a low degree of uniformity of brightness across the screen and a reduced yield in the heat treatment of the cathode ray tube.

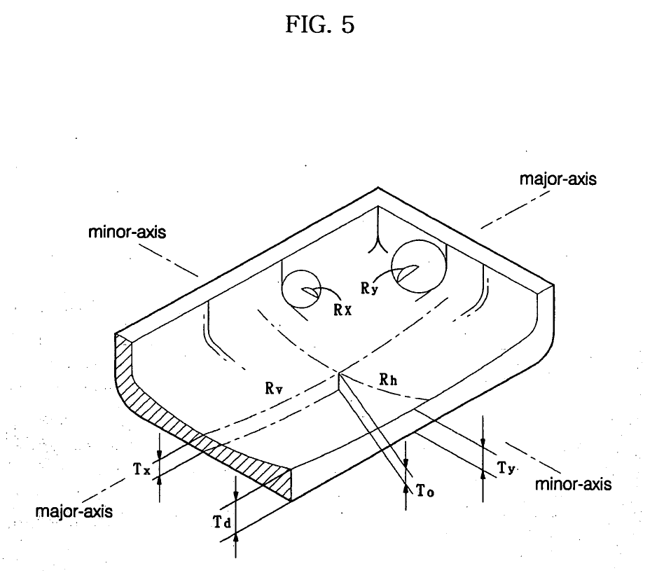

FIG. 5 is a schematic perspective view illustrating the wedge ratio of the panel in accordance with the present invention. As shown in FIG. 5, in the panel of the present invention wherein the outer surface thereof is substantially flat and the inner surface thereof has a predetermined curvature, the central region of the panel is thinner than an edge region of the effective screen of the panel. On the basis of such a configuration, a curvature radius and the thickness of respective regions of the panel are defined as follows.

In FIG. 5, Rₕ designates a minor-axis curvature radius of the inner surface of the panel, Rᵥ designates a major-axis curvature radius of the inner surface of the panel, Rₓ designates a curvature radius of the inner surface along a longer side of the panel, R_{y} designates a curvature radius of the inner surface along a shorter side of the panel, Tₒ designates a thickness of the central region of the panel, Td designates a thickness of a diagonal-axis end portion of the panel, T_{y} designates a thickness of a minor-axis end portion of the panel, and Tₓ designates a thickness of a major-axis end portion of the panel. In this case, the wedge ratio of the panel can be defined by the ratio of the thickness Tₒ of the central region of the panel to the thickness T_{d} of the diagonal-axis end portion of the panel, namely, the value of T_{d}/Tₒ.

The following Table 2 represents comparative results between the wedge ratio obtainable from the configuration of the panel according to the present invention as represented in Table 1 and the wedge ratio of the conventional panels.

TABLE 2

| | Ex. | Tₓ | T_{y} | T_{d} | | | | |
|---|---|---|---|---|---|---|---|---|
| | No. | (mm) | (mm) | (mm) | T_{y}/Tₓ | T_{d}/Tₓ | T_{d}/T_{y} | T_{d}/Tₒ |
| The | 1 | 13.89 | 14.06 | 19.55 | 1.01 | 1.41 | 1.39 | 2.33 |
| present | 2 | 14.99 | 15.16 | 20.65 | 1.01 | 1.38 | 1.36 | 2.17 |
| invention | 3 | 15.99 | 16.16 | 21.65 | 1.01 | 1.35 | 1.34 | 2.06 |
| The prior | 1 | 18.90 | 15.27 | 23.70 | 0.81 | 1.25 | 1.55 | 2.26 |
| art | 2 | 17.59 | 14.54 | 21.65 | 0.83 | 1.23 | 1.49 | 2.06 |

As shown in Table 2, the wedge ratio of the panel according to the present invention is increased as compared to the prior art. Such an increase of the wedge ratio results in a low degree of uniformity of brightness across the screen and a low yield in the heat treatment of the cathode ray tube, disabling achievement of a high quality of the cathode ray tube. In order to solve the problems, the present invention proposes that the curvature radius Rₒ of the outer surface of the panel is in the range of 5000 mm to 30000 mm since a brightness difference between the central and edge regions of the screen decreases as the curvature radius of the outer surface of the panel decreases.

In this case, the ratio of the thickness Tₓ of the major-axis end portion of the panel to the thickness T_{d} of the diagonal-axis end portion of the panel, namely, the value of T_{d}/Tₓ, is greater than or equal to 1.3.

Further, the thickness T_{d} of the diagonal-axis end portion of the panel is less than or equal to 24 mm, and the ratio of the thickness T_{y} of the minor-axis end portion of the panel to the thickness T_{d} of the diagonal-axis end portion of the panel, namely, the value of T_{d}/T_{y}, is less than or equal to 1.4.

The panel of the present invention configured as stated above exhibits a geometric configuration wherein the minor-axis curvature radius Rₕ of the inner surface of the panel is smaller than the major-axis curvature radius Rᵥ of the inner surface of the panel, resulting in a largely-curved shape in the minor-axis direction as compared to the shape in the major-axis direction.

Meanwhile, the panel of the cathode ray tube is spaced apart from a shadow mask formed with electron beam passage holes by a predetermined distance. This arrangement, however, has a problem in that the panel deteriorates the structural strength of the shadow mask as the curvature radius of the inner surface thereof increases. In order to solve the problem and to achieve a desired structural strength of the shadow mask, in the present invention, the curvature radius Rₓ of the inner surface along the longer side of the panel is greater than the curvature radius R_{y} of the inner surface along the shorter side of the panel. In this case, the diagonal-axis curvature radius R_{di} of the inner surface of the panel is greater than the diagonal-axis curvature radius Rₓ of the inner surface along the longer side of the panel, but is less than the curvature radius R_{y} of the inner surface along the shorter side of the panel. Such a diagonal-axis curvature radius R_{di} of the panel is less than or equal to 1800 mm.

Further, in the panel of the cathode ray tube, a contrast character thereof, indicating the image quality of the cathode ray tube, is variable according to a transmissibility Tm of light through the front side of the panel. Here, the light is produced as electron beams, emitted from electron guns, strike phosphors applied onto the inner surface of the panel. In general, glass having a high transmissibility is referred to as clear glass, whereas glass having a low transmissibility is referred to as tint glass.

Although the clear glass and the tint glass show different brightness and contrast characters from each other, the panel of the present invention can be made of any one of them. Of course, in consideration of manufacturing costs and a production yield of the panel, it is preferable that the panel of the present invention is made of the tint glass. In the case of the tint glass made panel, a transmissibility of the central region thereof is in a range of 45% to 75%.

As can be understood from the above description, the panel according to the first embodiment of the present invention is generally reduced in length and thickness except for the diagonal length USD of the effective screen thereof, achieving weight reduction and productivity improvement of the cathode ray tube, and reducing material costs thereof. Further, by virtue of an optimized structure of the panel and funnel of the cathode ray tube, the degree of breakage during the heat treatment of the cathode ray tube is lowered, improving the yield of the cathode ray tube.

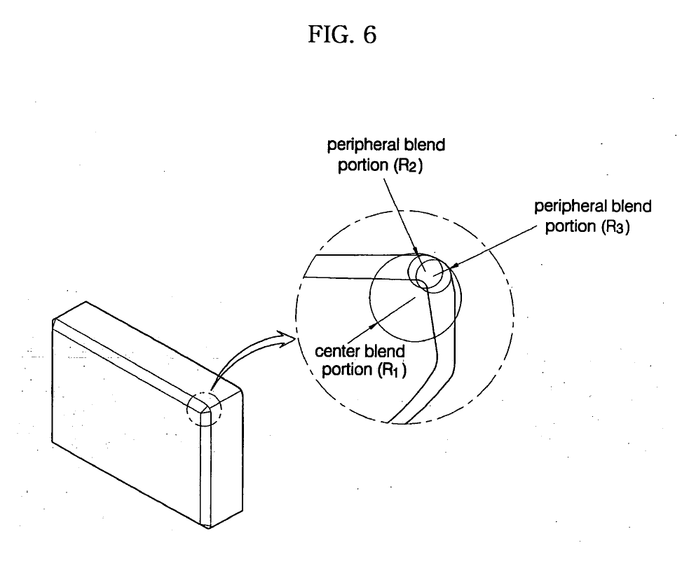

In the present invention, in order to more effectively achieve weight reduction of the cathode ray tub and to prevent stress concentration on specific regions thereof, the panel of the present invention is configured as shown in FIG. 6.

FIG. 6 is a perspective view, partially shown at an enlarged scale, illustrating a corner of the panel having predetermined curvatures at ends of outer longer and shorter edge surfaces and of an outer diagonal surface portion of the panel. The outer corners of the panel are customarily easy to damage upon receiving an external shock since they form stress convergence portions. As shown in FIG. 6, in the present invention, each of the outer corners of the panel is formed with blend portions at the ends of the outer longer and shorter edge surfaces and of the outer diagonal surface portion of the panel. In this case, it is important that the blend portions must not invade into the effective screen of the panel. The blend portions include a center blend portion and a pair of peripheral blend portions, and have predetermined curvatures, respectively. More particularly, the center blend portion has a curvature radius R₁ of 20 mm or more, and the peripheral blend portions have curvature radii R₂ and R₃ of 3 mm or more.

As a result of forming the blend portions at the thickest portions of the panel where the ends of the longer and shorter edge surfaces and of the outer diagonal surface portion meet, the overall weight of the panel is reduced, and the respective corners of the panel exhibit even stress distribution, resulting in an increased structural strength thereat.

However, the weight reduction of the panel may disadvantageously increase the vacuum stress caused after the evacuation of the cathode ray tube. Herein, the vacuum stress refers only to a tensile vacuum stress caused when the interior of the cathode ray tube is vacuumized, except for a compressive stress. Furthermore, a reduced thickness of the panel deteriorates its ability of shielding X-rays generated during operation of the cathode ray tube.

In order to solve the above problems, the present invention proposes to provide the panel with a compressive stress layer having a predetermined compressive stress value. Such a compressive stress layer is made of a material having a high X-ray absorption coefficient. In this case, preferably, a thickness of the compressive stress layer is greater than or equal to 30 micrometers, and the X-ray absorptive material contains any one selected from a group consisting of SrO, BaO and ZnO.

The vacuum stress value of the cathode ray tube according to the present invention configured as stated above, as shown in Table 1, is substantially equal to or smaller than the vacuum stress value of the prior art, increasing shock-resistance of the cathode ray tube so as to be durable against an external shock, and reducing the possibility of breakage thereof. The cathode ray tube of the present invention, further, can effectively intercept X-rays generated during operation thereof.

### Second Embodiment

The following Table 3 represents comparative results between a conventional cathode ray tube and the cathode ray tube of the present invention in view of vacuum stress values. In the present embodiment, the curvature radius Rₒ of the outer surface of the panel is in a range of 5000 mm to 100000 mm, the diagonal length USD of the effective screen of the panel is in a range of 450 mm to 500 mm, and other length and thickness of respective regions of the panel are given as follows.

TABLE 3

| | | | | | | | | | Vacuum | |
|---|---|---|---|---|---|---|---|---|---|---|
| | | | | | | | | | Stress | |
| | Ex. | OAH | CFT | USD | OAH/ | (OAH * CFT)/ | Tm | Tm | (Mpa) | |
| | No. | (mm) | (mm) | (mm) | USD | USD | (%) | (%) | panel | funnel |
| The | 1 | 65 | 8.4 | 457.2 | 0.142 | 1.194 | 83.7 | 61.8 | 6.6 | 5.4 |
| present | 2 | 59 | 8.4 | 457.2 | 0.129 | 1.084 | 83.7 | 61.8 | 6.3 | 5.1 |
| invention | 3 | 64 | 9.5 | 457.2 | 0.140 | 1.330 | 82.8 | 58.8 | 6.9 | 5.7 |
| | 4 | 60 | 9.5 | 457.2 | 0.131 | 1.247 | 82.8 | 58.8 | 6.7 | 5.5 |
| | 5 | 65 | 10.5 | 457.2 | 0.142 | 1.493 | 81.9 | 56.1 | 6.4 | 5.5 |
| | 6 | 61 | 10.5 | 457.2 | 0.133 | 1.401 | 81.9 | 56.1 | 6.0 | 4.9 |
| The prior | 1 | 78.5 | 11.0 | 457.2 | 0.173 | 1.901 | 81.5 | 54.8 | 7.2 | 5.9 |
| art | 2 | 79 | 11.5 | 457.2 | 0.173 | 1.987 | 81.5 | 54.8 | 6.8 | 5.6 |

As shown in Table 3, comparing the length and thickness of the respective regions of the panel according to the present invention with those of the prior art, it will be appreciated that the thickness CFT of the central region of the panel according to the present invention is smaller than that of the prior art, and that the distance OAH from the outer surface of the panel to the sealing surface between the panel and the funnel is smaller than that of the prior art.

That is, in order to prevent the breakage of the cathode ray tube due to an external shock and to achieve weight reduction of the cathode ray tube, the panel of the cathode ray tube according to the present embodiment employs a value of (OAH*CFT)/USD in a range of 1.0 to 1.7. Assuming that the diagonal length USD of the effective screen of the panel is in a range of 450 mm to 500 mm, if the value of (OAH*CFT)/USD is less than 1.0, both the distance OAH and the thickness CFT are excessively reduced, deteriorating the structural strength and explosion-proof character of the panel against an external shock. Conversely, if the value of (OAH*CFT)/USD is greater than 1.7, it makes impossible to achieve weight reduction of the cathode ray tube, increasing material costs thereof. This also increases a thickness of a peripheral region of the panel, resulting in a high degree of breakage during the heat treatment of the cathode ray tube, deteriorating a yield thereof.

As another technical solution for preventing the breakage of the cathode ray tube due to an external shock and achieving weight reduction of the cathode ray tube, the panel of the present embodiment employs the thickness CFT in the central region of the panel of 10 mm and less. In consideration of the tolerance error in design of different various cathode ray tubes or a reduction of material costs through weight reduction of the panel, the thickness CFT is preferably in a range of 8 mm to 9 mm.

In this case, the ratio of the diagonal length USD of the effective screen of the panel to the distance OAH from the outer surface of the panel to the sealing surface between the panel and the funnel, namely, the value of OAH/USD is less than or equal to 0.17.

Meanwhile, in the same manner as the above described first embodiment, the wedge ratio of the panel increases as the thickness CFT of the panel decreases, exhibiting a low degree of uniformity of brightness across the screen and a low yield in the heat treatment of the cathode ray tube.

The following Table 4 represents comparative results between the wedge ratio obtainable from the configuration of the panel according to the present invention as represented in Table 3 and the wedge ratio of the conventional panels.

TABLE 4

| | Ex. | Tₓ | T_{y} | T_{d} | | | | |
|---|---|---|---|---|---|---|---|---|
| | No. | (mm) | (mm) | (mm) | T_{y}/Tₓ | T_{d}/Tₓ | T_{d}/T_{y} | T_{d}/Tₒ |
| The | 1 | 15.66 | 15.76 | 21.81 | 1.01 | 1.39 | 1.38 | 2.60 |
| present | 2 | 16.76 | 16.88 | 22.91 | 1.01 | 1.37 | 1.36 | 2.41 |
| invention | 3 | 17.76 | 17.86 | 23.91 | 1.01 | 1.35 | 1.34 | 2.28 |
| The prior | 1 | 21.17 | 16.26 | 26.46 | 0.77 | 1.25 | 1.63 | 2.41 |
| art | 2 | 21.67 | 16.76 | 26.96 | 0.77 | 1.24 | 1.61 | 2.34 |

As shown in Table 4, the wedge ratio of the panel according to the present invention is increased as compared to the prior art. Such an increase of the wedge ratio results in a low degree of uniformity of brightness across the screen and a low yield in the heat treatment of the cathode ray tube, disabling achievement of a high quality of the cathode ray tube. In order to solve the problems, the present invention proposes that the curvature radius Rₒ of the outer surface of the panel is in the range of 5000 mm to 30000 mm since a brightness difference between the central and edge regions of the screen decreases as the curvature radius of the outer surface of the panel decreases.

In this case, the ratio of the thickness Tₓ of the major-axis end portion of the panel to the thickness T_{d} of the diagonal-axis end portion of the panel, namely, the value of T_{d}/Tₓ, is greater than or equal to 1.3.

Further, the thickness T_{d} of the diagonal-axis end portion of the panel is less than or equal to 24 mm, and the ratio of the thickness T_{y} of the minor-axis end portion of the panel to the thickness T_{d} of the diagonal-axis end portion of the panel, namely, the value of T_{d}/T_{y}, is less than or equal to 1.4.

The panel of the present invention configured as stated above exhibits a geometric configuration wherein the minor-axis curvature radius Rₕ of the inner surface of the panel is smaller than the major-axis curvature radius Rᵥ of the inner surface of the panel, resulting in a largely-curved shape in the minor-axis direction as compared to the shape in the major-axis direction.

Meanwhile, the panel of the cathode ray tube is spaced apart from a shadow mask formed with electron beam passage holes by a predetermined distance. This arrangement, however, has a problem in that the panel deteriorates the structural strength of the shadow mask as the curvature radius of the inner surface thereof increases. In order to solve the problem and to achieve a desired structural strength of the shadow mask, in the present invention, the curvature radius Rₓ of the inner surface along the longer side of the panel is greater than the curvature radius R_{y} of the inner surface along the shorter side of the panel. In this case, the diagonal-axis curvature radius R_{di} of the inner surface of the panel is greater than the diagonal-axis curvature radius Rₓ of the inner surface along the longer side of the panel, but is less than the curvature radius R_{y} of the inner surface along the shorter side of the panel. Such a diagonal-axis curvature radius R_{di} of the panel is less than or equal to 1800 mm.

As can be understood from the above description, the panel according to the second embodiment of the present invention is similar to that of the first embodiment of the present invention, except for the diagonal length USD of the effective screen of the panel, the values of (OAH*CFT)/USD and OAH/USD, and the like. Further, the present embodiment employs the same technical solutions as the first embodiment for intercepting X-rays generated during operation of the cathode ray tube and for preventing convergence of vacuum stress.

The vacuum stress value of the cathode ray tube according to the present embodiment configured as stated above, as shown in Table 3, is substantially equal or smaller than the vacuum stress value of the prior art, increasing shock-resistance of the cathode ray tube so as to be durable against an external shock, and reducing the possibility of breakage thereof. The cathode ray tube of the present invention, further, can effectively intercept X-rays generated during operation thereof.

As apparent from the above description, the present invention provides a color cathode ray tube comprising the optimized structure of a panel and funnel, which is capable of reducing manufacturing costs through weight reduction thereof, and of lowering the degree of breakage during a heat treatment step included in a manufacturing process of the cathode ray tube, resulting in an improved yield.

Further, through the optimized structure of the panel and funnel of the cathode ray tube, it is possible to reduce a vacuum stress generated in the cathode ray tube, and to provide the cathode ray tube with a high degree of shock-resistance so as to be durable against an external shock.

Furthermore, according to the present invention, the cathode ray tube can effectively shield X-rays generated during operation thereof, so as not to be harmful to the human body.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A color cathode ray tube comprising:
a panel having a fluorescent plane formed at an inner surface thereof;
a funnel sealed to the panel in a vacuumized state;
electron guns mounted in a neck portion of the funnel and adapted to emit electron beams to the fluorescent plane;
a deflection yoke mounted in a yoke portion of the funnel and adapted to deflect the electron beams; and
a shadow mask spaced apart from the fluorescent plane formed at the inner surface of the panel by a predetermined distance for color selection,
wherein: the panel is configured to satisfy an expression:
1.0≦(OAH*CFT)/USD≦1.5,
where, OAH is a distance from the outer surface of the panel to a sealing surface between the panel and the funnel, USD is a diagonal length of an effective screen of the panel, and CFT is a thickness of a central region of the panel.

2. The tube as set forth in claim 1, wherein the diagonal length of the effective screen of the panel is less than or equal to 500 mm.

3. The tube as set forth in claim 2, wherein the diagonal length of the effective screen of the panel is in a range of 400 mm to 450 mm.

4. The tube as set forth in claim 1, wherein the thickness of the central region of the panel is less than or equal to 10 mm.

5. The tube as set forth in claim 4, wherein the thickness of the central region of the panel is in a range of 8 mm to 9 mm.

6. The tube as set forth in claim 1, wherein a ratio of the diagonal length of the effective screen of the panel to the distance from the outer surface of the panel to the sealing surface between the panel and the funnel is less than or equal to 0.15.

7. The tube as set forth in claim 1, wherein the panel has a curvature radius of the outer surface thereof ranging from 5000 mm to 100000 mm.

8. The tube as set forth in claim 7, wherein the curvature radius of the outer surface of the panel is in a range of 5000 mm to 30000 mm.

9. The tube as set forth in claim 1, wherein a ratio of a thickness of a major-axis end portion of the panel to a thickness of a diagonal-axis end portion of the panel is greater than or equal to 1.3.

10. The tube as set forth in claim 1, wherein a thickness of the diagonal-axis end portion of the panel is less than or equal to 24 mm.

11. The tube as set forth in claim 1, wherein a ratio of a thickness of a minor-axis end portion of the panel to a thickness of a diagonal-axis end portion of the panel is less than or equal to 1.4.

12. The tube as set forth in claim 1, wherein the panel has a diagonal-axis curvature radius of the inner surface thereof of 1800 mm and less.

13. The tube as set forth in claim 1, wherein the panel has a light transmissibility at the central region thereof ranging from 45% to 75%.

14. The tube as set forth in claim 1, wherein the panel has a center blend portion and peripheral blend portions formed at ends of outer longer and shorter edge surfaces and of an outer diagonal surface portion converged at a corner of the panel, and
wherein the center blend portion has a curvature radius of 20 mm or more, and the peripheral blend portions have curvature radii of 3 mm or more, respectively.

15. The tube as set forth in claim 1, wherein an X-ray absorptive material is applied to the surface of the panel.

16. The tube as set forth in claim 15, wherein the X-ray absorptive material contains any one selected from a group consisting of SrO, BaO and ZnO.

17. A color cathode ray tube comprising:
a panel having a fluorescent plane formed at an inner surface thereof;
a funnel sealed to the panel in a vacuumized state;
electron guns mounted in a neck portion of the funnel and adapted to emit electron beams to the fluorescent plane;
a deflection yoke mounted in a yoke portion of the funnel and adapted to deflect the electron beams; and
a shadow mask spaced apart from the fluorescent plane formed at the inner surface of the panel by a predetermined distance for color selection,
wherein the panel is configured so that a curvature radius of an outer surface thereof is in a range of 5000 mm to 100000 mm, a diagonal length of an effective screen thereof is in a range of 450 mm to 500 mm, and it satisfies an expression:
1.0≦(OAH*CFT)/USD≦1.7,
where, OAH is a distance from the outer surface of the panel to a sealing surface between the panel and the funnel, CFT is a thickness of a central region of the panel, and USD is the diagonal length of the effective screen of the panel.

18. The tube as set forth in claim 17, wherein the thickness of the central region of the panel is less than or equal to 10 mm.

19. The tube as set forth in claim 18, wherein the thickness of the central region of the panel is in a range of 8 mm to 9 mm.

20. The tube as set forth in claim 17, wherein a ratio of the diagonal length of the effective screen of the panel to the distance from the outer surface of the panel to the sealing surface between the panel and the funnel is less than or equal to 0.17.

21. The tube as set forth in claim 17, wherein the curvature radius of the outer surface of the panel is in a range of 5000 mm to 30000 mm.

22. The tube as set forth in claim 17, wherein a ratio of a thickness of a major-axis end portion of the panel to a thickness of a diagonal-axis end portion of the panel is more than 1.3.

23. The tube as set forth in claim 17, wherein a thickness of a diagonal-axis end portion of the panel is less than or equal to 24 mm.

24. The tube as set forth in claim 17, wherein a ratio of a thickness of a minor-axis end portion of the panel to a thickness of a diagonal-axis end portion of the panel is less than or equal to 1.4.

25. The tube as set forth in claim 17, wherein the panel has a diagonal-axis curvature radius of the inner surface thereof of 1800 mm and less.

26. The tube as set forth in claim 17, wherein the panel has a light transmissibility at the central region thereof ranging from 45% to 75%.

27. The tube as set forth in claim 17, wherein the panel has a center blend portion and peripheral blend portions formed at ends of outer longer and shorter edge surfaces and of an outer diagonal surface portion converged at a corner of the panel, and
wherein the center blend portion has a curvature radius of 20 mm or more, and the peripheral blend portions have curvature radii of 3 mm or more, respectively.

28. The tube as set forth in claim 17, wherein an X-ray absorptive material is applied to the surface of the panel.

29. The tube as set forth in claim 28, wherein the X-ray absorptive material contains any one selected from a group consisting of SrO, BaO and ZnO.

30. A color cathode ray tube comprising:
a panel having a fluorescent plane formed at an inner surface thereof;
a funnel sealed to the panel in a vacuumized state;
electron guns mounted in a neck portion of the funnel and adapted to emit electron beams to the fluorescent plane;
a deflection yoke mounted in a yoke portion of the funnel and adapted to deflect the electron beams; and
a shadow mask spaced apart from the fluorescent plane formed at the inner surface of the panel by a predetermined distance for color selection, wherein:
a thickness of a central region of the panel is less than or equal to 10 mm;
a light transmissibility at the central region of the panel is in a range of 45% to 75%; and
the panel has a center blend portion and peripheral blend portions formed at ends of outer longer and shorter edge surfaces and of an outer diagonal surface portion converged at a corner of the panel, the center blend portion having a curvature radius of 20 mm or more, the peripheral blend portions having curvature radii of 3 mm or more, respectively.
